(19) United States
(12) Patent Application Publication
(10) Pub. No.: US 2010/0318512 A1
(43) Pub. Date: Dec. 16, 2010

(54) ADVANCED GEOGRAPHIC INFORMATION SYSTEM (GIS) PROVIDING MODELING, DECISION SUPPORT, VISUALIZATION, SONIFICATION, WEB INTERFACE, RISK MANAGEMENT, SENSITIVITY ANALYSIS, SENSOR TELEMETRY, FIELD VIDEO, AND FIELD AUDIO

(76) Inventor: Lester F. LUDWIG, Belmont, CA (US)

Correspondence Address: Lester F. Ludwig, P.O. Box 128, Belmont, CA, 94002, US

(21) Appl. No.: 12/817,074

(22) Filed: Jun. 16, 2010

Related U.S. Application Data
(60) Provisional application No. 61/268,873, filed on Jun. 16, 2009.
(60) Provisional application No. 61/239,426, filed on Sep. 2, 2009.
(60) Provisional application No. 61/239,428, filed on Sep. 2, 2009.

(51) Int. Cl. G06F 17/30

(52) U.S. Cl. 707/722; 707/E17.018

(57) ABSTRACT

An advanced Geographic Information System (GIS) providing modeling, analysis, Multicriteria Decision Analysis (MCDA), data visualization, data sonification, web interface, risk management, sensitivity analysis, and telemetry capabilities is described. Telemetry can be provided by field sensors, field video, and/or field audio, and can be recorded or provided live in either direct or analyzed form. Data visualizations can be displayed along with GIS graphics, and can be superimposed or otherwise integrated with GIS graphics. GIS graphics can be used as the basis for an interactive user interface for other parts of the system. Web interfaces can support remote use, server based implementations, and/or collaboration. Advanced multi-channel data sonification can be used to prevent visual overloading of GIS graphics and interactions with it. The system can include rich data processing capabilities and interconnections of these so as to facilitate powerful data visualization and sonification results and can support multidimensional user interface devices.

### CROSS-REFERENCE TO RELATED APPLICATIONS

This application claims benefit of priority of U.S. provisional application Ser. No. 61/268,873 filed on Jun. 16, 2009, and U.S. provisional applications Ser. No. 61/239,426 and 61/239,428, both filed Sep. 2, 2009. All three provisional applications are incorporated herein by reference.

### BACKGROUND OF THE INVENTION

1. Field of the Invention

The present invention generally relates to a spatial information system, such as geographic information system (GIS) provided with additional features motivated by the cited problems and observations.

2. Background of the Invention

A geographic information system (GIS), also referred to as a geographical information system, is in the broadest sense any system that captures, stores, analyzes, manages, and presents data that are linked to a geographic location. In among the simplest terms, GIS is the merging of cartography and database technology. GIS systems are used in cartography, remote sensing, land surveying, utility management, photogrammetry, geography, urban planning, emergency management, navigation, and localized search engines.

In a general sense, the term GIS describes any information system that integrates, stores, edits, analyzes, shares, and displays geographic information. In a more generic sense, GIS applications are tools that allow users to create interactive queries (user-created searches), analyze spatial information, edit data, maps, and present the results of all these operations. It is noted that the acronym “GIS” is also sometimes used for “Geographic Information Science,” a field that is regarded as the science underlying the geographic concepts, applications and systems.

Given the vast range of GIS and geographic spatial analysis techniques that have been developed over the past half century, any summary or review can only cover the subject to a limited depth. This is a rapidly changing field, and GIS packages are increasingly including analytical tools as standard built-in facilities or as optional toolsets, add-ins or ‘analysts’. In many instances such facilities are provided by the original software suppliers (commercial vendors or collaborative non commercial development teams), while in other cases facilities have been developed and are provided by third parties. The impact of these myriad paths to perform spatial analysis create a new dimension to business intelligence termed “spatial intelligence” which, when delivered via intranet, democratizes access to operational sorts not usually privy to this type of information.

GIS systems to date have had at best extremely limited, if any, incorporation of the following technologies that would add considerable new values, markets, and opportunities for good:
Analytical Models: Many developing, evolving, and emerging environmental contamination situations are not well-defined contaminated sites, in particular at the urban and industry interfaces with waterways. Contamination transport of and through groundwater is essentially unaddressed by many surface water tools, and spatial distributions of chemical reactions and of bioprocesses breaking down contaminants in surface water, groundwater, soil, etc. are not included in these tools or GIS systems.
Data Visualization: Many analytic tool outcomes produce data that lend themselves well to helpful visualizations (both in geospatial formats and in abstract-data formats). In highly cluttered visual displays, advanced data sonification can be used to convey yet additional data without further encumbering the visual field; however most sonification work is far too primitive or inappropriate for GIS applications.
Data Sonification: Sonification is the use of non-speech audio to convey information or perceptualize data. Due to the specifics of auditory perception, such as temporal and pressure resolution, it forms an interesting alternative or complement to visualization techniques, gaining importance in various disciplines. It has been well established for a long time already as Auditory Display in situations that require a constant awareness of some information (e.g. vital body functions during an operation). To date, data sonification has remained a novelty area, and the use of sonification as a method for exploration of data and scientific modeling is a ongoing topic of low-level research. However, sonfication can be an extremely powerful tool is if data is expressed in terms of parameterized timbre variations.
Field-located Sensors: Powerful new sensor capabilities and telemetry costs are radically evolving and improving yet are not integrated into contamination data systems or GIS utilities. Narrow-scope tools limit the potential customer-base for these technologies which in turn limits the availability of the tools, competitive innovation, and constituent awareness. Video and audio field sensors can provide very useful environmental information but are usually not considered as a useful field technology. Despite the success of the web and public outreach of applications such as Google Maps/Terrain/Satellite, no effort has been made to provide a browser-based functionality for GIS-driven environmental analysis systems.
Multidimensional User Input Devices: GIS and data navigation tools in GIS systems traditionally are limited to the 2D mouse or trackball. However, because of the complexity of the data and the large number of possible geometric operations, orientations, representations, and metaphors used, higher-dimensional user-interface input devices with at least additional interactively adjustable user-interface input parameters if not 3D-geometry if not 6D-geometry (x,y,z, roll, pitch, yaw) capabilities could add tremendous value.
Decision Support Tools: In cases where decisions are to be made from GIS information and/or models operating on it and/or other data, it would be very useful to include safeguards and interactive sensitivity analysis features in Multicriteria Decision Analysis (MCDA) analysis software tools integrated into the system.

The present invention addresses these problems with a system comprising of GIS data system, display, handling, and user interface utilities synergistically integrated with at least the following additional technology features:
1. Environmental modeling systems such as Adaptive Risk Assessment Modeling System (ARAMS™), FishRand, TrophicTrace, etc. ARAMS™ is based on a widely accepted risk paradigm that integrates exposure and effects assessments to characterize risk incorporating various existing databases and models for exposure, intake/update, and effects (health impacts) into an object-oriented, conceptual site modeling framework. FishRand is a two-dimensional probabilistic bioaccumulation model originally developed to support decision making at the Hudson River Superfund Site. TrophicTrace is an executable program that can be used to calculate, with inputs provided by users, potential human health and ecological risks due to bioaccumulation of sediment-associated contaminants.);
2. Pollutive emission calculation and forecast models such as SEMM (a fossil fuel demand calculation, forecast and prediction tool; manual available at http://www.ssb.no/histstat/doc/doc 199506.pdf).
3. Multicriteria Decision Analysis tools (employing, for example, Bayesian, multi-attribute value theory (MAVT), multi-attribute utility theory (MAUT), Analytic Hierarchy Process (AHP), outranking methods) with added sensitivity analysis features and usage appropriate safeguards;
4. Spatial data interpolation tools such as Kriging methods (Kriging methods are a group of geostatistical techniques to interpolate the value of a random field—e.g., the elevation as a function of the geographic location—at an unobserved location from observations of its value at nearby locations. The theory behind interpolation and extrapolation by kriging was developed by the French mathematician Georges Matheron based on the Master's thesis of Daniel Gerhardus Krige, the pioneering plotter of distance-weighted average gold grades at the Witwatersrand reef complex in South Africa.);
5. Output data visualization and roles for six-degree-of-freedom navigation interfaces;
6. Data sonification systems;
7. Spatial chemical reaction process models;
8. Spatial transformational (i.e, non-accumulation) bioprocess models;
9. Ground-water contamination transport models;
10. Field sensor telemetry data feeds and data recording;
11. Use of specialized and need-emergent field sensors;
12. Web-compatible browser-based interactive user interfaces (such a user interface can be used to provide a field-wireless terminal using a laptop or tablet computer); and
13. Field video and audio sensor feeds, sampling, and segment recording.

In particular, inclusion of one or more of above listed features 5-13 will considerably expand the capabilities, attractiveness, and market interest for the resultant technology, and as a result will greatly expand the potential customer base. Additionally, this overarching approach and architectures comprised by the invention can be used to create standards and interfaces. These in turn can be used to grow the industry as new sensors, analysis software, and science emerge.

The invention seeks to serve as an enabling technology for widened and wiser environmental management of contaminated industrial and military sites and to provide widespread economic benefits to public and private industry. The invention provides a wide-range of integrated enabling evolvable features detected towards, among other goals, effective, efficient and successful environmental management of land use, water use, the cleanup of contaminated sites, etc.

End users of the invention can include military and other federal agencies as well as city, county and state municipalities, real estate developers, litigation teams, environmental organizations, environmental research groups, industrial polluters, mining operations, parks, museums, roadside facility kiosks, schools and farms.

### SUMMARY OF THE INVENTION

In one embodiment, the invention comprises a user-controlled software environment for linking the input of a multi-criteria decision analysis (MCDA) system with the output of the one or more of the aforementioned models. In some implementations, the MCDA is provided with a plurality of choices or ranges over which to optimize. Additionally, the MCDA is provided with utility/value metrics and weightings.

In an embodiment, the invention comprises driving one or more of the aforementioned models with information from GIS data sets and/or other data outputs of a GIS, for example data selected within a GIS via the GIS interactive user interface. The invention provides for the GIS display to include non-GIS visualization overlay capabilities. The invention provides for the GIS to incorporate Kriging methods for spatial interpolations of data values.

In an embodiment, the invention comprises a GIS data selection utility using Google Maps/Terrain/Satellite in a web browser interface. In such an embodiment, HTML (HyperText Markup Language), XTML (Extensible Markup Language), and XML (Extensible Markup Language) and associated text and graphics primitives can be used for implementing functionality of an interactive GIS interface, and can also be used as part of architectures for a web-server-based implementation of the system. Such web-server-based implementation of the system can additionally be used to link to wireless terminals inexpensively rendered from standard off-the-shelf wireless WAN laptop or tablet computers.

In an embodiment, the invention comprises integration of one or more of a groundwater transport, spatial chemical reaction, and spatial bioprocess models. These can be meaningfully used and integrated into the proposed system. In an embodiment, the FRAMES (Framework for Risk Analysis in Multimedia Environmental Systems) 2.0 Software System (available from Pacific Northwest National Laboratory operated by Battelle for the United States Department of Energy under Contract DE-AC05-76RL01830.) can be used, for example via an Application Programmers Interface (API), to provide integration of groundwater transport and chemical reaction modeling systems. In an embodiment, chemical process modeling software can be used to analytically account for reactive chemical transformations and associated contaminant breakdowns. In an embodiment, bioprocess modeling software can be used to analytically account for micro-organism populations and associated contaminant breakdowns.

In an embodiment, the invention comprises an integration of data visualization tools. Although at least some primitive form of data visualization can be provided by a GIS system, additional visualization models and functionality can be included for representing outcome data for analysis software results. These outcome representations can be rendered in a GIS context and/or in the contest of abstract data sets. The invention provides for adding rich visualization tools to MCDA functions, for example in perturbation analysis on utility and value assignments that are often somewhat subjectively determined. Although some MCDA outputs can naturally lend themselves to GIS representations (for example, where to begin a dredging, where to do sample testing, etc.), many MCDA outputs will be more abstract. Visualizations can include 2D and 3D visualizations, and can render with application specific graphics primitives, operating system graphics primitives, web browser graphics primitives, etc., individually or in combination.

In an embodiment, data visualization graphics is displayed superimposed on the GIS graphics.

In an embodiment, a six-degree-of-freedom data navigation user input devices can be used to navigate and/or interactively control a visualization, an underlying model producing data for the visualization, a combination of these, or other arrangements.

In an embodiment, the user can navigate a user observing viewpoint within data visualization.

In an embodiment, the invention comprises deeply integrated data visualization of data from various models, tools, and data sets. In an embodiment, the invention provides visualizations of analysis output data as well as selected measurement data.

In an embodiment, data visualization is rendered either in a GIS display context or in an abstract data set context, as appropriate. In an embodiment, the invention provides for data visualization to be used to support interactive adjustments of analysis software tools.

In an embodiment, the invention comprises use and integration of real-time sensor telemetry feeds, data sampling from these, and real-time recorded segments of continuous measurement intervals. These can be incorporate to create or align with GIS data, GIS display, and/or serve as input to various analytical models and software tools provided for by the invention. Example sensors that can be used include pH, oxygen, temperature, flow-rate sensors, light-level, turbidity, ion, and affinity sensors.

In an embodiment, the invention provides for the use of a field-deployable surface water remote flow-microscope imaging sensor for flowing surface water. Such a flow-microscope imaging sensor can be introduced into the flow of a flowing waterway and provide live telemetry. In an embodiment, the invention comprises sensor data sampling and continuous time recording utilities. In an embodiment, the invention can merge or associate such data with other data in a GIS system and/or GIS data set.

In an embodiment, the invention can comprise the integration of an inexpensive commercially available meteorology instrumentation and associated data logging systems.

In an embodiment, the invention comprises use and integration of real-time video telemetry feeds, data sampling from these, and real-time recorded segments of continuous measurement intervals.

In an embodiment, the invention incorporates one or more of the above into the user interface, the GIS display.

Field telemetry video can provide valuable information on fauna populations and behavior, weather, seasonal sunlight distribution, water levels, erosion processes, bank migration, delta formation, sudsing, slicks, discoloration, trash density, ice formation, etc.

In an embodiment, the invention provides spatially distributed cameras selectable in a GIS context.

In an embodiment, the invention comprises sensor data sampling and continuous time recording utilities.

In an embodiment, the invention can merge or associate such data with other data in a GIS system and/or GIS data set.

In an embodiment, the invention provides pop-up video windows displaying live and/or recorded and/or stored still-frame video from multiple spatially distributed cameras and microphones.

Field telemetry audio can provide useful information on fauna populations and spatial behavior (bird, frog, insect voicing), water flow noise, wind noise, etc. In an embodiment, the invention provides spatially distributed microphones selectable in a GIS context.

In an embodiment, the invention comprises sensor data sampling and continuous time recording utilities. In an embodiment, the invention can merge or associate such data with other data in a GIS system and/or GIS data set.

In an embodiment, the invention provides audio play-out of live and/or recorded audio from one or more multiple spatially distributed microphones.

In an embodiment, the invention provides for separate audio and video streams to be separately stored with time code or other provisions that provide for synchronized playback. In an embodiment, the invention provides for separate audio and video streams to be co-recorded for synchronized playback.

In an embodiment, the invention provides for an integrated user interface and user experience providing resultant synergistic capabilities resulting from the integration.

In an embodiment, the invention comprises an integration of data sonification tools to provide practical, useful sonification representations for data that would otherwise clutter visually busy or crowded graphical GIS displays. Although always seeming to hold interesting promise, sonification to date is often not very useful or practical. The invention provides for use of a family of signal synthesis, control, and metaphor techniques and technologies for examining environmental, science, business and engineering datasets.

In an embodiment, the invention comprises “multi-channel sonification” using data-modulated sound timbre classes set in a spatial metaphor stereo sound field In an embodiment, the invention comprises inexpensive 2D speaker and 2D/3D headphone audio to provide a richer spatial-metaphor sonification environment.

In an embodiment, the invention comprises deeply integrated data sonification of data from various models, tools, and data sets. In an embodiment, the invention provides sonification of analysis software output data as well as selected measurement data.

In an embodiment, the invention, sonification will be rendered either in a GIS display context or in an abstract data set context, as appropriate. In an embodiment, the invention provides for sonification to be used to support interactive adjustments of analysis software tools.

In an embodiment, the user can navigate a user observing listening point within a data sonification.

In an embodiment, the invention comprises an integration of data sonification tools to provide practical, useful sonification representations for data that would otherwise clutter visually busy or crowded graphical GIS displays. Although always seeming to hold interesting promise, sonification to date is often not very useful or practical. The invention provides for use of a family of signal synthesis, control, and metaphor techniques and technologies for examining environmental, science, business and engineering datasets. In an embodiment, the invention comprises “multichannel sonification” using data-modulated sound timbre classes set in a spatial metaphor stereo sound field. In an embodiment, the invention comprises inexpensive 2D speaker and 2D/3D headphone audio to provide a richer spatial-metaphor sonification environment.

In an embodiment, the invention comprises deeply integrated data sonification of data from various models, tools, and data sets. In an embodiment, the invention provides sonification of analysis software output data as well as selected measurement data. In an embodiment, the invention, sonification will be rendered either in a GIS display context or in an abstract data set context, as appropriate. In an embodiment, the invention provides for sonification to be used to support interactive adjustments of analysis software tools.

In an embodiment, the user can navigate a user observing listening point within a data sonification.

In some embodiments, one or more presentation tools can exchange data with one or more presentation tools and/or one or more analysis software tools. In some embodiments, one or more analysis software tools can exchange data with one or more presentation tools and/or one or more analysis software tools. Many variations are possible and are provided for by the invention.

### BRIEF DESCRIPTION OF THE DRAWINGS

The above and other aspects, features, and advantages of the present invention will become more apparent upon consideration of the following description of preferred embodiments, taken in conjunction with the accompanying drawing figures.

FIG. 1 depicts an exemplary representation of an exemplary traditional GIS system.

FIG. 2a depicts an exemplary traditional GIS data environment comprises cartographic data and exogenous measurement data associated with GIS linkages

FIG. 2b depicts an exemplary embodiment of the invention wherein the traditional GIS data environment depicted in FIG. 2a is additionally provided with expanded GIS data environments comprising data from sensor telemetry, video/image telemetry, and audio telemetry which also can be associated with shared and/or differing GIS linkages.

FIG. 2c depicts an exemplary embodiment of the invention wherein the traditional GIS data environment depicted in FIG. 2a is additionally provided with additional data processing and data representations.

FIG. 2d an exemplary embodiment of the invention combining the arrangements of FIG. 2b and FIG. 2c.

FIG. 3 depicts exemplary user interface dataflow aspects of an exemplary embodiment as provided for by the invention.

FIG. 4 shows an exemplary arrangement wherein a geographic data set can be associated with effective or explicit attachments, and further examples of how, In an embodiment, data can be selected from one or more of the geographic data, (effective or actual) attachments, and/or a user interface.

FIG. 5 illustrates a simple exemplary arrangement of an embodiment wherein one or more data analysis software tools provide information to one or more decision tools.

FIG. 6a shows an exemplary geological water structure comprising soil, sediment, surface water, groundwater, surface water flow, percolation zone, and confined aquifer.

FIG. 6b shows pollution source dripping into unconfined aquifer through a crack in a barrier rock layer between an unconfined aquifer and a confined aquifer.

FIG. 7 shows an exemplary embodiment of an in situ flow microscope as can be deployed as a remote telemetry sensor.

FIG. 8 shows an exemplary arrangement provided for by the invention comprising an oxygen sensor, pH sensors, and flow microscope in contact with the flowing waterway, and further comprising a plurality of cameras placed on the shoreline so as to show different environmental views.

FIG. 9 shows an exemplary arrangement provided for by the invention comprising an oxygen sensor and pH sensor that are positioned in the flowing waterway.

FIG. 10 depicts a traditional method for analyzing and collecting data for a GIS system. Known data is provided to analysis software tools

FIG. 11 depicts an exemplary arrangement provided for by the invention

FIG. 12 illustrates an exemplary embodiment wherein GIS Data provides information to GIS Interactive User Interface, which in turn provides information to Environmental Analysis Models, which in turn provides information to MCDA tools, which in turn provides Result Data.

FIG. 13 depicts a first additional exemplary arrangement provided for by the invention that adds more capabilities to the arrangement of FIG. 12.

FIG. 14 depicts a second additional exemplary arrangement provided for by the invention that adds visualization capabilities to the arrangement of FIG. 13.

FIG. 15 illustrates an exemplary arrangement of selected more general aspects of the invention that are not restricted to spreadsheet visualization.

FIG. 16 illustrates an adaptation of the exemplary arrangement of FIG. 15 to a collaboration environment supporting exemplary collaboration features.

FIG. 17 depicts an exemplary topological interconnection of data flow paths linking various elements depicted in FIG. 15.

FIG. 18 depict exemplary approaches for mapping a data value lying within a pre-defined range to a value within a pre-defined range for a parameterized data or cell presentation attribute.

FIG. 19 depicts an exemplary arrangement and general organization of exemplary pre-visualization operations wherein a native data set is presented to normalization, shifting, (nonlinear) warping, and/or other functions, index functions, and sorting functions.

FIG. 20 depicts an exemplary embodiment wherein a selected metaphor is used to automatically generate parameter assignments and graphics rendering operations in data visualization.

FIG. 21 shows an exemplary embodiment wherein interactive user controls and/or other parameters are used to assign an index to a data set in data sonification.

FIG. 22 shows “multichannel sonification” using data-modulated sound timbre classes set in a spatial metaphor stereo sound field.

FIG. 23 shows an exemplary embodiment where dataset is provided to sonification mappings controlled by interactive user interface.

FIG. 24 shows an exemplary embodiment of a three-dimensional partitioned timbre space.

FIG. 25 shows exemplary partitions allowing the user to sufficiently distinguish separate channels of simultaneously produced sounds, even if the sounds time modulate somewhat within the partition.

FIG. 26 shows an example of how, through proper sonic design, each timbre space coordinate can support a plurality of partition boundaries.

FIG. 27 depicts a flow path provided by a user interface.

### DETAILED DESCRIPTION

In the following detailed description, reference is made to the accompanying drawing figures which form a part hereof, and which show by way of illustration specific embodiments of the invention. It is to be understood by those of ordinary skill in this technological field that other embodiments can be utilized, and structural, electrical, as well as procedural changes can be made without departing from the scope of the present invention. Wherever possible, the same element reference numbers will be used throughout the drawings to refer to the same or similar parts.

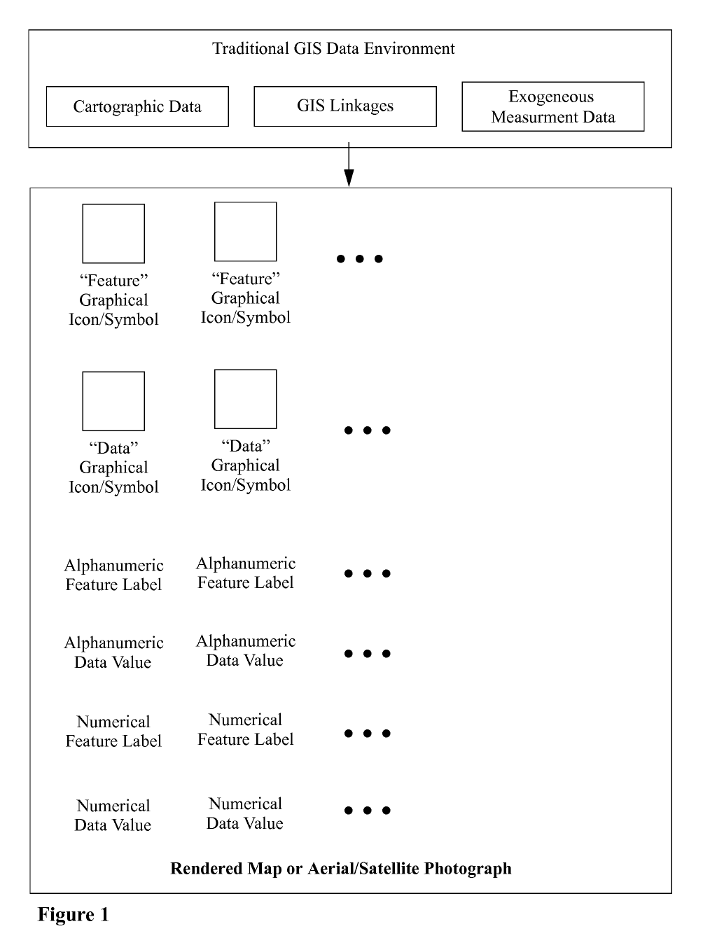

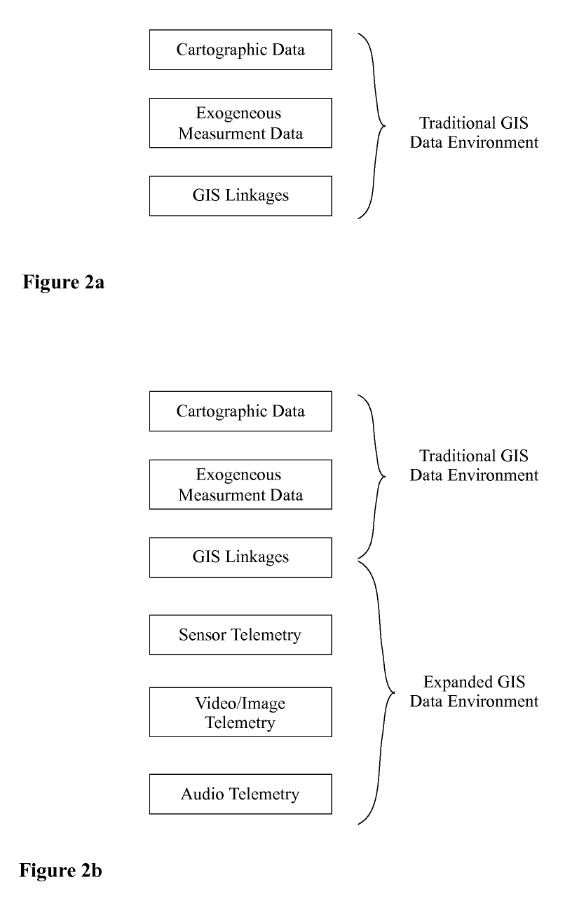

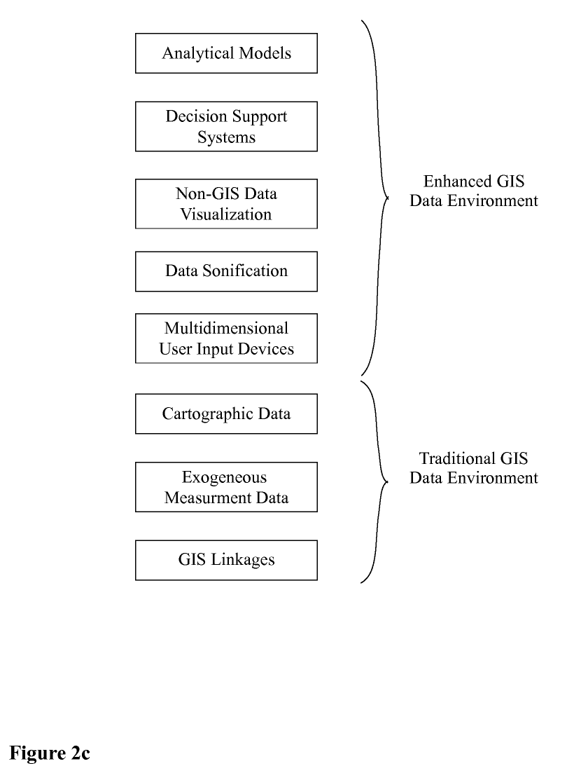

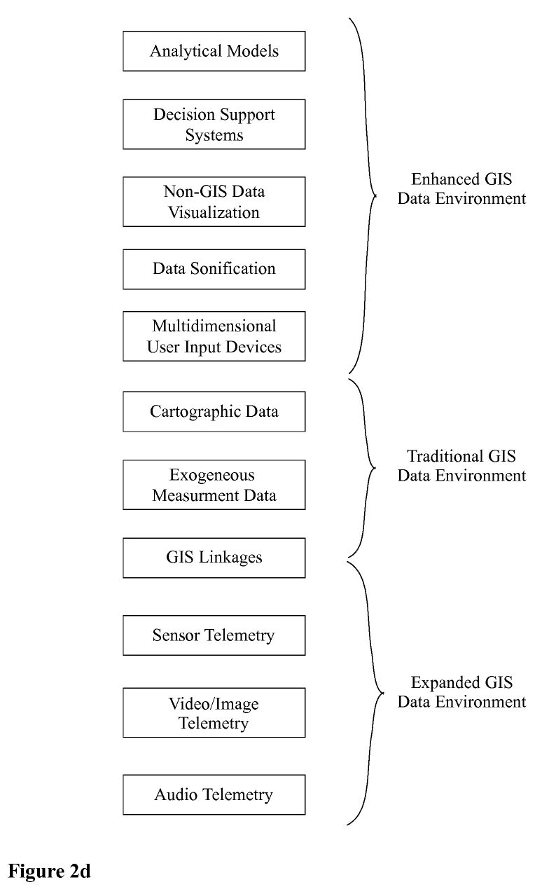

FIG. 1 depicts an exemplary representation of an exemplary traditional GIS system. Here cartographic data, GIS linkages, an exogenous measurement data provide an exemplary traditional GIS data environment. The data in this data environment can be used to populate a vector-graphic map or overlay a raster image map (graphically produced, aerial photograph, satellite image, etc. with additional icons, symbols, text, and/or numerical values. In the exemplary arrangement on FIG. 1 these can include one or more of:
graphical icons and/or symbols denoting (geographic or data) features;
graphical icons and/or symbols denoting data values;
Alphanumeric text denoting (geographic or data) features;
Alphanumeric text denoting data values;
Numerical text denoting (geographic or data) features;
Numerical text denoting data values.
   One skilled in the art will appreciate that many variations on this example can be made. Extracting from FIG. 1, FIG. 2a depicts an exemplary traditional GIS data environment comprises cartographic data and exogenous measurement data associated with GIS linkages.

### Incorporation of Sensor Telemetry Data

The invention can include sensor data sampling and continuous time recording utilities. The invention can also merge or associate such data with other data in a GIS system or GIS data set. The invention can further comprise the integration of inexpensive commercially available meteorology instrumentation and associated data logging systems.

The invention uses and integrates stored and real-time data from sensor telemetry feeds. Data can be sampled from these feeds as isolated sample times or as real-time recorded segments of continuous measurement intervals. These can be stored for later use, and at a later time the stored sensor telemetry data can incorporated to create or align with GIS data, GIS display, and/or to serve as input to various analytical models and software tools provided for by the invention. Examples of sensors that can be used include pH, oxygen, temperature, flow-rate sensors, light-level, turbidity, ion, and affinity sensors. The invention provides for the use of a field-deployable surface water remote flow-microscope imaging sensor for flowing surface water. Such a flow-microscope imaging sensor can be introduced into the flow of a flowing waterway and provide live telemetry.

The invention provides for live real-time sensor telemetry data and/or previously recorded segments of continuous measurement intervals to be displayed or otherwise presented by a user interface and/or the GIS display. Field telemetry video can provide valuable information on fauna populations and behavior, weather, seasonal sunlight distribution, water levels, erosion processes, bank migration, delta formation, sudsing, slicks, discoloration, trash density, ice formation, etc. The invention has spatially distributed cameras selectable in a GIS context. Sensor data sampling and continuous time recording utilities can be merged or associated with other GIS data and displayed live and/or recorded and/or stored still-frame video from multiple spatially distributed cameras and microphones.

Sampled data from real-time audio telemetry feeds and real-time recorded segments of continuous measurement intervals are incorporated into the user interface, the GIS display. Field telemetry audio can provide useful information on fauna populations and spatial behavior (bird, frog, insect voicing), water flow noise, wind noise, etc. Spatially distributed microphones are selectable in a GIS context and the audio data from the selected microphones is reproduced live or recorded.

Separate audio and video streams can be separately stored with time codes or other provisions that provide for synchronized playback.

An integrated user interface provides synergistic capabilities resulting from the integration.

FIG. 2b shows the traditional GIS data environment provided with expanded GIS data environments comprising data from sensor telemetry, video/image telemetry, and audio telemetry which also can be associated with shared and/or differing GIS linkages.

One or more presentation tools can exchange data with each other or one or more analysis software tools. Many variations are possible and are provided for by the invention. FIG. 2c shows the traditional GIS data environment depicted in FIG. 2a additionally provided with additional data processing and data representations.

FIG. 2d shows a combination of the arrangements shown in FIG. 2b and FIG. 2c.

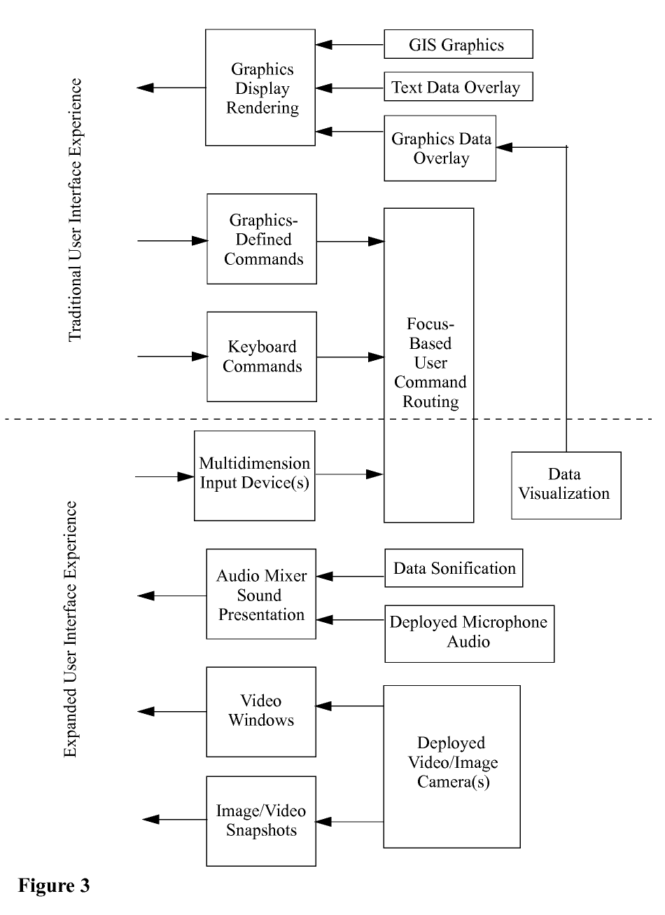

FIG. 3 shows aspects of a user interface dataflow for one embodiment. A traditional GIS user interface comprises elements such as:
Graphics Display Rendering,
Graphics-Defined Commands,
Keyboard Commands,
GIS Graphics,
Text Data Overlay,
Focus-Based User Command Routing,
Expanded GIS user interface experience comprising elements such as:
   A. Multidimensional Input Device(s) (for example, 3D, 6D, Advanced Mouse, etc.),
   B. Data Visualization
   C. Data Sonification,
   D. Audio Mixer Sound Presentation,
   E. Video Camera Display Windows,
   F. Image/Video Camera Snapshot Display Windows.
      The Graphics Data Overlay can use output from Data Visualization in the Expanded User Interface Experience. The Data Visualization element and/or Data Sonification element can be provided with one or more of direct GIS data, recorded measurement data, live measurement data streams, data outputs from analytical models, data outputs from Multicriteria Decision Tools, etc.

Regarding coupling of additional data to GIS data, FIG. 4 shows that a geographic data set can be associated via effective, implicit, or explicit attachments. These attachments can comprise exogenous measurements, attributes, and notations as well as sensor information, data, and/or measurements. Here sensors can include audio and/or video transducers as well as one or more of pH sensors, oxygen sensors, methane sensors, temperature sensors, flow-rate sensors, light-level sensors, turbidity sensors, ion sensors, and affinity sensors. A field-deployable surface water remote flow-microscope imaging sensor for flowing surface water can be used. FIG. 4 also shows how data can be selected from one or more of the geographic data, (effective or actual) attachments, and/or a user interface. In FIG. 4, selected data can be provided to one or more presentation tools and/or one or more analysis software tools.

Alternatively, data records and/or streams can be simply associated with GIS data and/or locations one a map or spatially-indexed image.

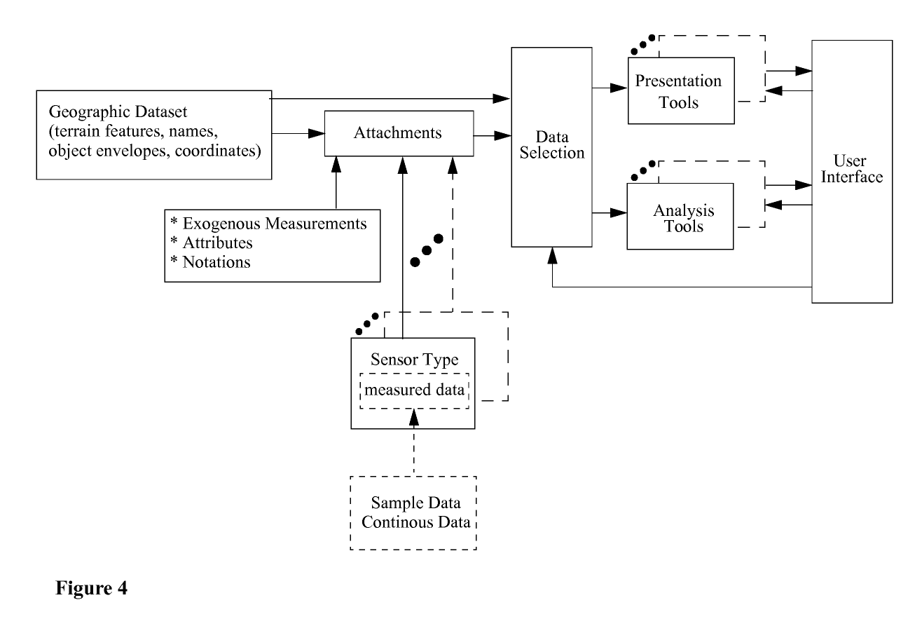

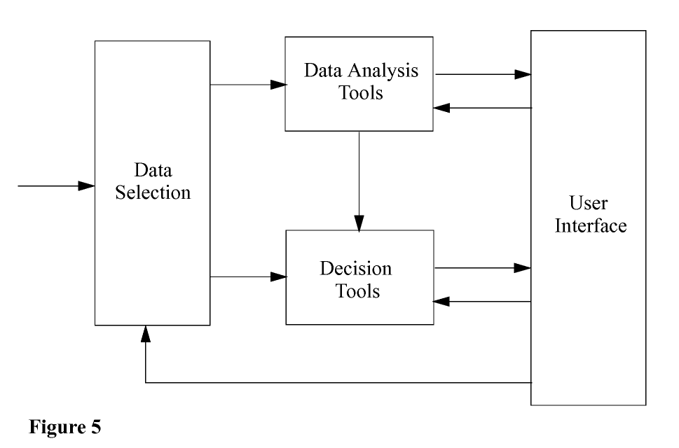

Regarding the data and control flows among data analysis software tools, decision tools, data selection elements, and user interface elements, FIG. 5 illustrates one arrangement wherein one or more data analysis software tools provide information to one or more decision tools. The analysis and decision software tools provide information to the user interface, and the user interface can provide information to the data selection element. Many variations are possible and are provided for by the invention.

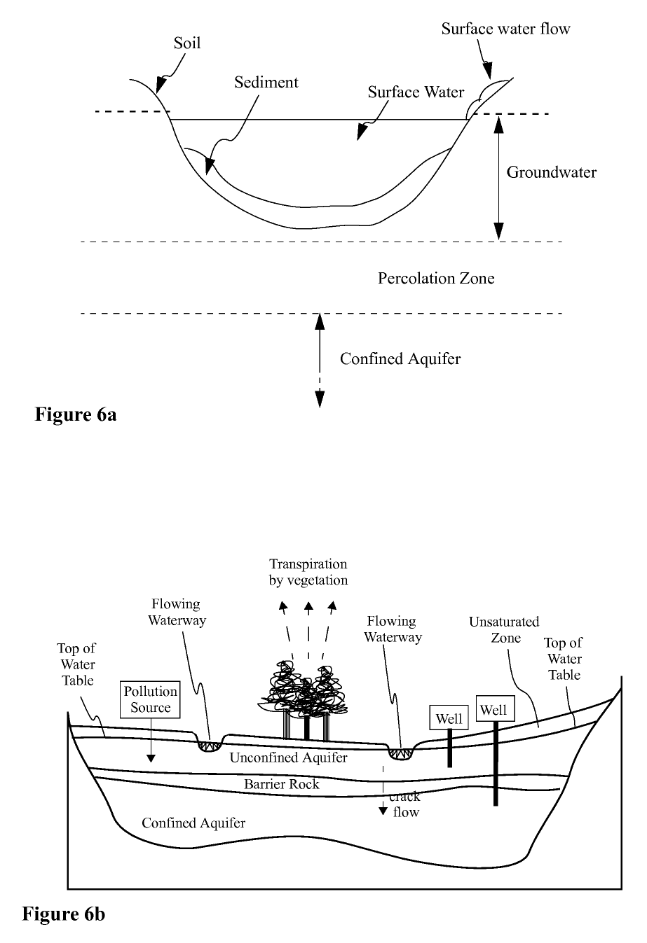

One or more of a groundwater transport, spatial chemical reaction, and spatial bioprocess models can be integrated into the proposed system. As an example of groundwater and surface water situations that could be represented, modeled, and analyzed by the invention, FIG. 6 shows an exemplary geological water structure comprising soil, sediment, surface water, groundwater, surface water flow, and confined aquifer. In this example a percolation zone separates ground water and the confined aquifer. The confined aquifer can serve as a water source for a community, farm, region, etc.

As an example of groundwater software models, an adaptation of the FRAMES (Framework for Risk Analysis in Multimedia Environmental Systems) software system (available from Pacific Northwest National Laboratory operated by Battelle for the United States Department of Energy under Contract DE-AC05-76RL01830) can be used, for example via an Application Programmers Interface (API), to provide integration of groundwater transport and chemical reaction modeling systems. Chemical process modeling software can be used to analytically account for reactive chemical transformations and associated contaminant breakdowns. Bioprocess modeling software can be used to analytically account for micro-organism populations and associated contaminant breakdowns.

In a similar fashion, the invention can be configured to include somewhat less complex surface water and surface water flow models. Such models can include transport modeling, chemical reaction modeling, and bioprocess modeling systems. Chemical process modeling software can be used to analytically account for reactive chemical transformations and associated contaminant breakdowns, and bioprocess modeling software can be used to analytically account for micro-organism populations and associated contaminant breakdowns.

Surface water and groundwater are traditionally monitored by human field sampling. The invention provides for data obtained by human field sampling, and further provides for the use of field-deployed remote sensors in one or both of surface water and groundwater monitoring. As described earlier, these can provide (periodic, on-demand, or ongoing) recorded or live data streams to the invention, for example, as suggested in FIGS. 2b, 2d, and 4 and as to be discussed shortly in conjunction with FIG. 11, FIG. 13 and FIG. 14.

As another example of groundwater and surface water situations that could be represented, modeled, and analyzed by the invention, FIG. 6b shows pollution source dripping into unconfined aquifer through a crack in a barrier rock layer between an unconfined aquifer and a confined aquifer. The pollution source can leak thus down to confined aquifer through cracks in the barrier. As a result, the pollution source can contaminate water in wells drawing from both the unconfined aquifer and confined aquifer. The invention additionally provides for models to include point source (as pictured) or distributed source (particulate fall-out, polluted rain, urban runoff, etc.) contamination, ground water take-up from wells and foliage transpiration, as well as other processes that can improve the validity and accuracy of analytical modeling used in the invention.

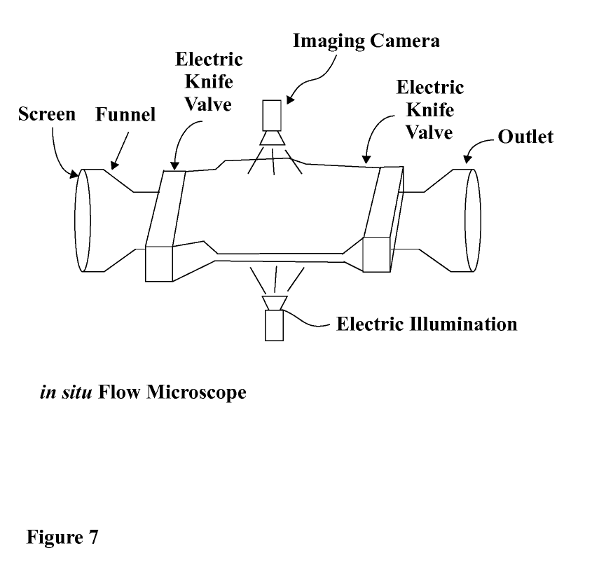

Regarding additional field measurement of surface water and also the use of image and video sensors and associated telemetry, FIG. 7 shows an example of an in situ flow microscope, such as that taught in U.S. patent application Ser. No. 12/______ filed on Jun. 16, 2010, that can be deployed as a remote telemetry sensor. Sampled and/or flowing surface water can flow into the funnel. The screen adjacent to the funnel can filter out debris in the water. Electric illumination provides light source from the bottom and a video and/or imaging camera on the opposite side of a transparent flat fluidic passageway captures the images of particles of microscopic organisms that are suspended in the water. The imaging camera can have magnifying lenses. One or more electric knife valve(s) can be operated to trap water for a fixed view. The electric knife valve(s) can be operated to remove debris at fluid constrictions.

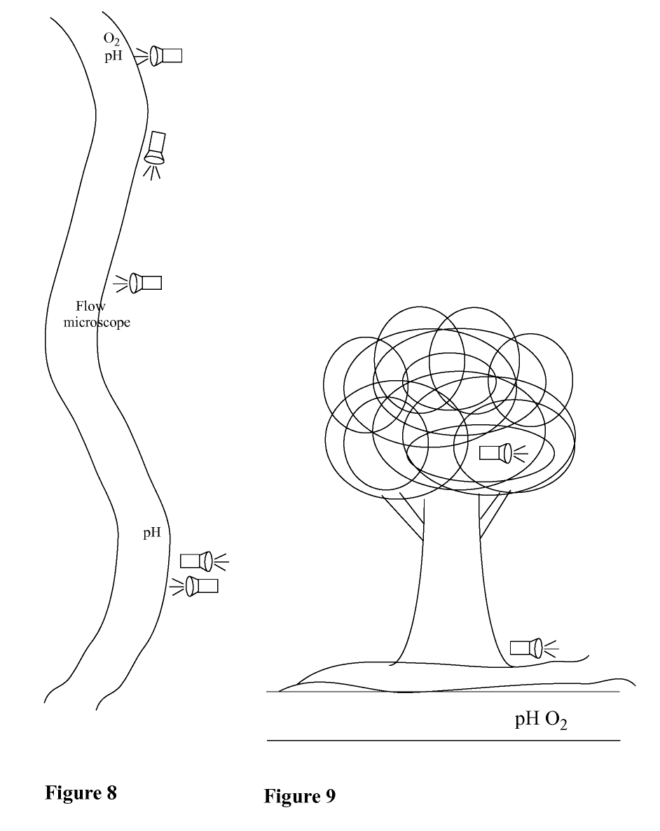

FIG. 8 shows various sensors and instruments, for example here a oxygen sensor, pH sensors, and flow microscope in contact with the flowing waterway. FIG. 8 further shows a plurality of video or still-image electronic cameras, placed for example on the shoreline capturing different environmental views over time. Use of such data was considered earlier, for example in conjunction with the discussion of FIG. 3. A graphic representation of the arrangement is shown in the visual user interface to select specific sensor data for display or processing or to spatially locate the display of specific sensor data. FIG. 9 shows another arrangement provided comprising an oxygen sensor and pH sensor that are positioned in the flowing waterway. FIG. 9 further shows at least one camera placed near or on the ground, and at least another camera elevated in a tree.

Incorporation of New Environmental and other GIS Data

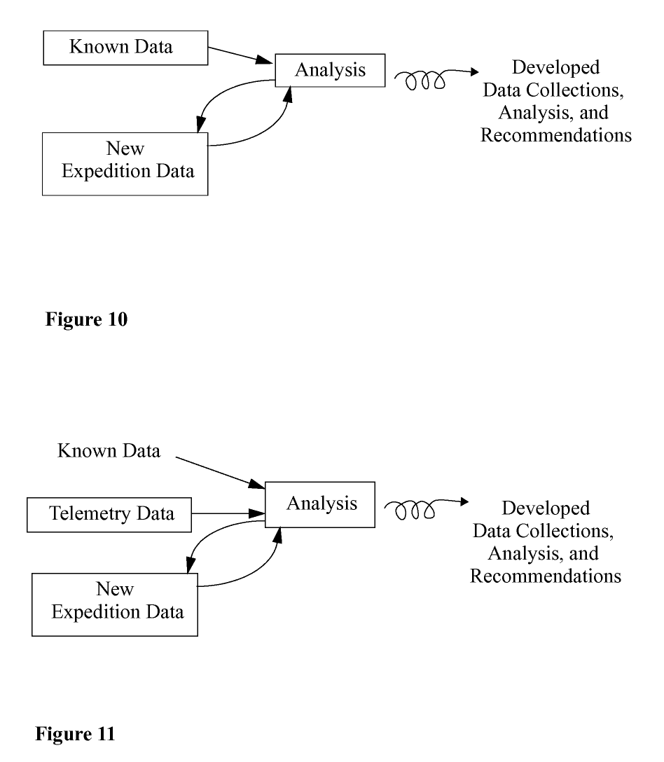

FIG. 10 depicts a traditional method for analyzing know and collected data for a GIS system and associated analysis software tools. As described earlier, the present invention improves over this by providing for GIS and other, environmental and other types of GIS data can be gathered by human field sampling and/or field sensors. Such human field sampling and/or field sensors can provide recorded data and/or live data streams. As described earlier in conjunction with FIG. 4, such data can be appended or associated with GIS data in various ways. For example, FIG. 11 depicts one arrangement provided for by the invention wherein telemetry from field sensors is additionally or alternatively presented to a GIS system and associated analysis software tools.

Processing of Data, Dataflow, and/or Information Streams by Models and Decision Support Tools

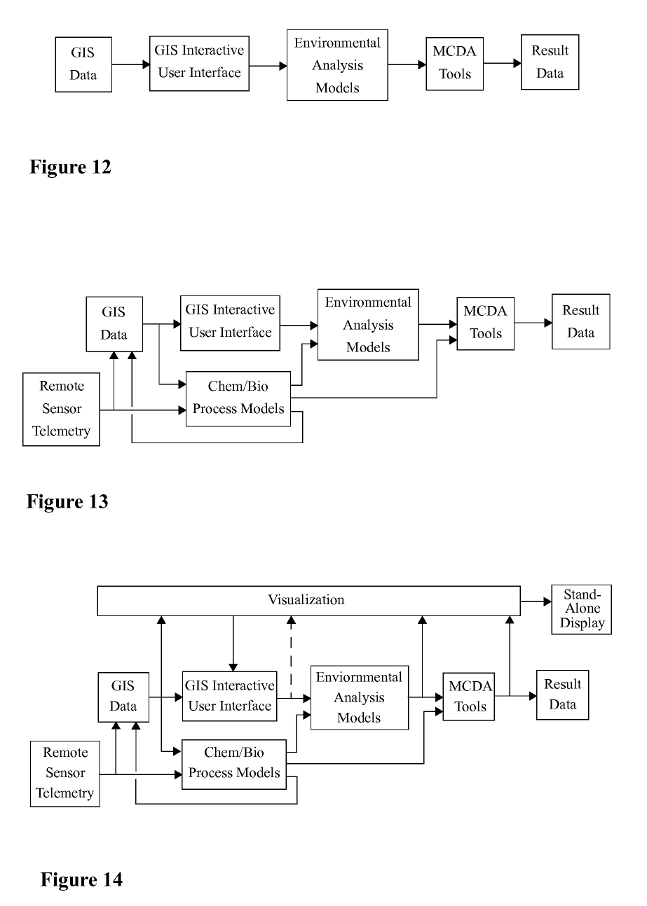

FIG. 12 shows GIS Data providing information to GIS Interactive User Interface, which in turn provides information to Environmental Analysis Models, which in turn provides information to MCDA tools, which in turn provides Result Data.

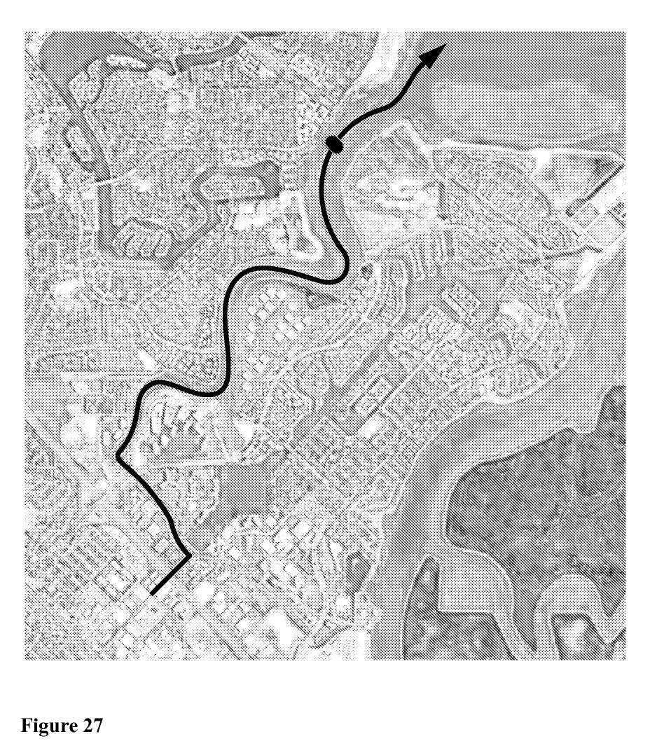

FIG. 13 depicts another arrangement of the invention that adds more capabilities to the arrangement of FIG. 12. For example chemical and/or biological process models can be included as shown, as well as other computer models (such as groundwater contaminant propagation, food chain, etc.) not shown. Additionally, field sensors can provide recorded data and/or live data streams via telemetry or other types of data exchange. FIG. 14 depicts an additional arrangement of the invention that adds data visualization capabilities to the arrangement of FIG. 13. The data visualization capabilities my also provide user interface features to various parts of the system (for example, to the GIS interactive user interface as shown). Further consideration of the use of data visualization display to be used as a basis for interactive user interface functions are considered later in conjunction with FIG. 27.

### Data Visualization

At least the data visualization aspects of the invention provide for the control of data presentation attributes through use of a uniform parameterization framework. This allows pre-visualization operations, such as scaling, translation, filtering, array (matrix, tensor) operations, nonlinear warping, etc. to be employed in a modular, cascadable fashion independent of the particular choice of data presentation attributes. The invention further provides for pre-visualization operations to themselves have parameters that can be adjusted in real time and/or be stored in files for recall. The invention further provides for a network of pre-visualization operations to be stored in files for recall.

At least the data visualization aspects of the invention additionally provides for advanced user interface devices, particularly those providing large numbers of simultaneously-adjustable interactive control parameters, to be used to control the viewing, presentation, and creation of the visualization as well as controlling the underlying data source such as databases, statistical packages, simulations, etc.

At least the data visualization aspects of the invention include:
the use of arbitrary or integrated data sources (such as static databases, dynamic databases, streaming databases, live sensing data streams, numerical simulations, signal processing, statistical processing, linear and nonlinear transformations, etc.);
uniform parameterizations of selected or all visualization presentation parameters;
the support for real-time updates to integrated data sources (such as static databases, dynamic databases, streaming databases, live sensing data streams, numerical simulations, signal processing, statistical processing, linear and nonlinear transformations, etc.);
the use of data flow paths to link arbitrary data sources with arbitrary data destinations via arbitrary topologies (graphically, via an interconnection, specification, and/or data-flow language, etc.);
the providing of shared GUI environments for controlling two or more of visualization rendering, pre-visualization operations, and data sources.

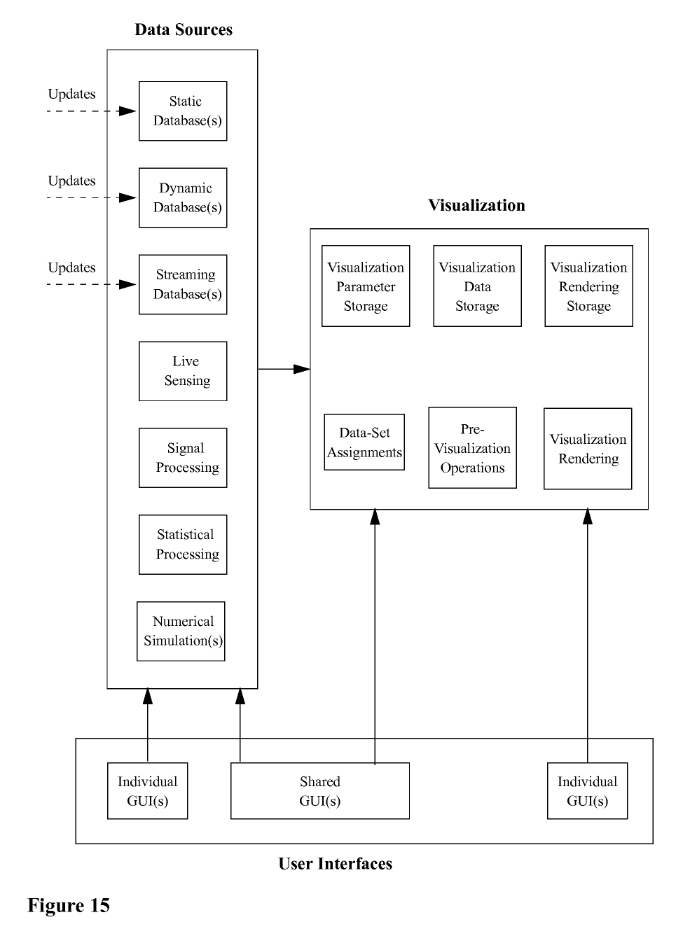

FIG. 15 shows an arrangement of these more general aspects of the invention. Implicit in FIG. 15 are further more general aspects of the invention, that support visual rendering in a browser window and/or as a web application. Yet additional more general aspects of the invention also include (real-time and non-real-time) collaboration capabilities.

Further, via web and/or other implementation approaches, the invention provides for implementation of at least data visualization presentation features in a collaborative interactive use environment.

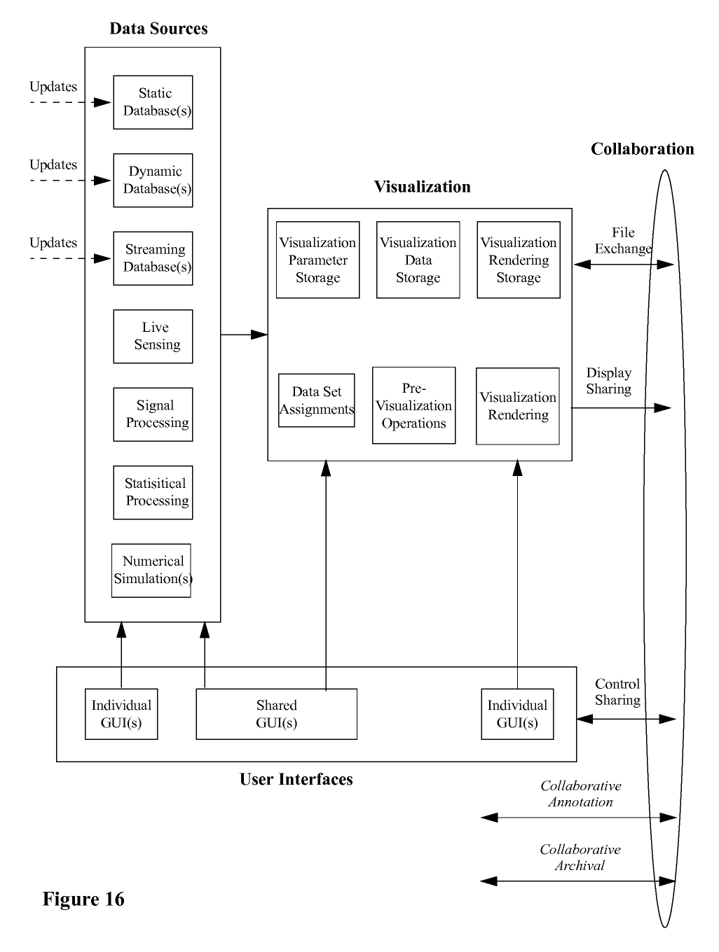

FIG. 16 illustrates an adaptation of an arrangement of FIG. 15 to a collaboration environment supporting collaboration features such as one or more of file exchange, real-time or stored display sharing, real-time control sharing, real-time or stored collaborative annotation, and archives of collaboration sessions and transactions.

At least the visualization aspects of the invention provides for uniform parameterizations of selected or all visualization presentation parameters. This allows pre-visualization operations, such as scaling, translation, filtering, array (matrix, tensor) operations, nonlinear warping, etc. to be employed in a modular, cascadable fashion independent of the particular choice of data and cell presentation attributes.

At least the visualization aspects of the invention provides for the use of data flow paths to link arbitrary data sources with arbitrary data destinations via arbitrary topologies. This allows the selection and/or fusion of data sources, their interconnection with selected signal processing, statistical processing, pre-visualization operations, and visualization parameters (such as, among other examples, and the cell and data presentation parameters of the spreadsheet visualization described earlier and in more detail to follow).

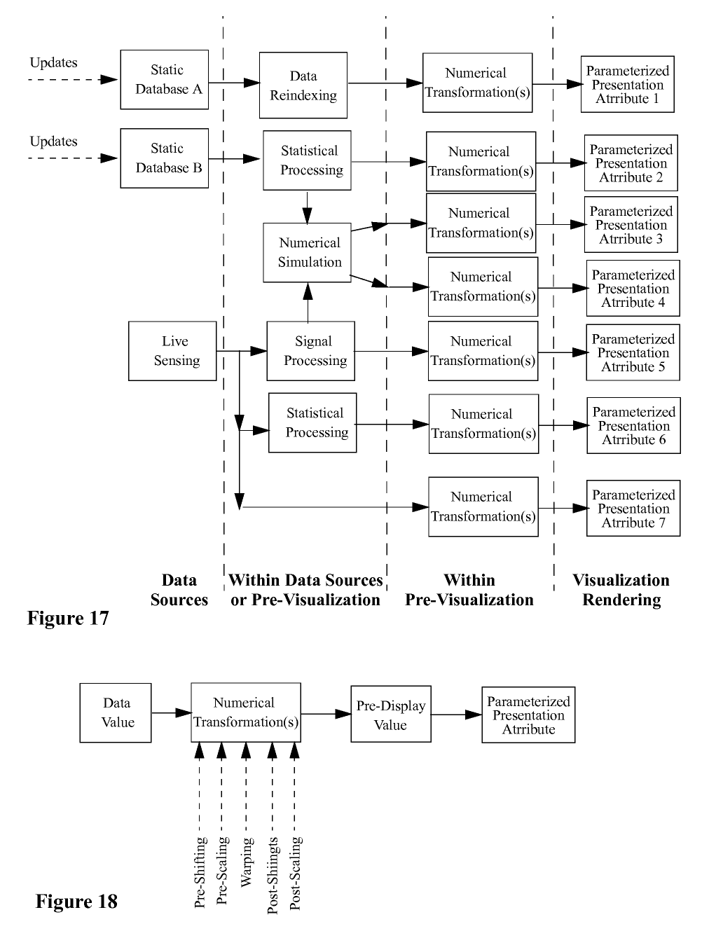

FIG. 17 depicts a topological interconnection of data flow paths linking various elements depicted in FIG. 15. Functions such as data reindexing, statistical processing, and signal processing can be provided as the data sources depicted in FIG. 15 or as the pre-visualization functions depicted in FIG. 15. Similarly, numerical simulations, as can be rendered by a high-performance or other computer, can be provided as the data sources depicted in FIG. 15. Certain pre-visualization functions, for example linear predictors, can in an embodiment be regarded as a numerical simulation. Additionally, in a spreadsheet visualization setting, calculations in the spreadsheet can provide a form of numerical simulation prior to visualization.

The invention provides for some or all of the data flow paths (such as depicted in the example of FIG. 17) to be specified in any convenient way, for example graphically via an interactive GUI or via a character-based language (interconnection, specification, and/or data-flow, etc.). In an exemplary embodiment, a GUI can permit the rendering of a graphic similar to that of FIG. 17. In an exemplary embodiment, a GUI can permit creation and customization of instances of functional blocks such as the ones depicted in FIG. 17 from a library, menu, and/or graphical pallet. In an exemplary embodiment, a GUI can be used to create and link these customized instances of functional blocks, via link-by-link “drawing,” with a data path topology such as the ones depicted in FIG. 17.

Attention is now directed to consideration of pre-visualization operations. FIG. 18 depict an exemplary approach for mapping a data value lying within a pre-defined range to a value within a pre-defined range for a parameterized data or cell presentation attribute. In most cases the input data range must be at least scaled and/or shifted so as to match the pre-defined range for a parameterized presentation attribute. In some circumstances it can also be desirable to warp the data range with a nonlinearity. A library of fixed or adjustable nonlinearities is provided as such that the input and output of the nonlinearity both match the pre-defined range for a parameterized presentation attribute. In another embodiment the warping effect is provided with additional flexibility by allowing pre-scaling and/or pre-shifting prior to applying a selected nonlinearity and subjecting the outcome of the nonlinear warping to post-scaling and/or post-shifting operations in order to match the resulting range to the pre-defined range for a parameterized presentation attribute. Such arrangements are representationally depicted in FIG. 18.

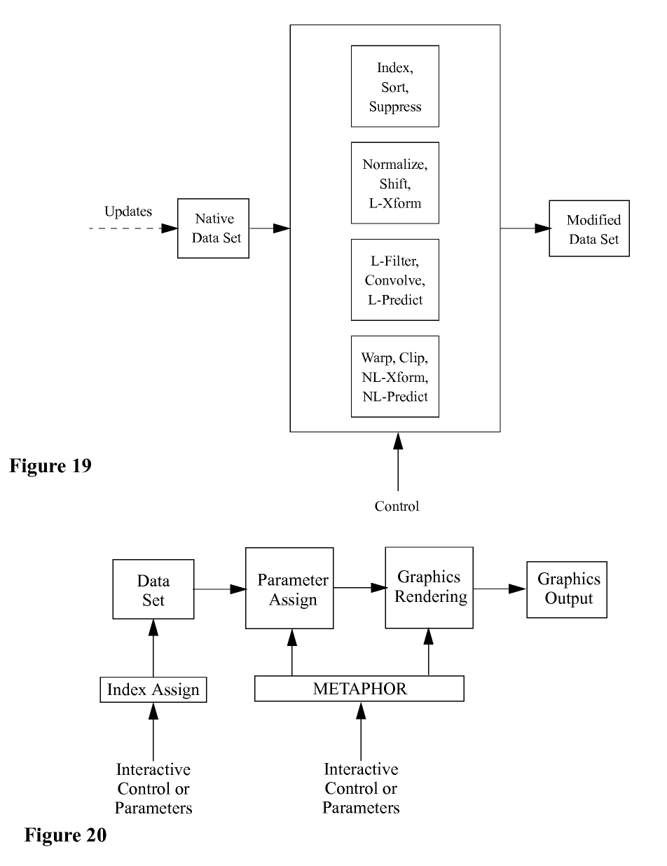

FIG. 19 depicts a more general view and organization of pre-visualization operations provided for by the invention. In this example, available pre-visualization operations include:
Data indexing/reindexing, data sorting, data suppression, and similar types of data operations;
Normalization, shifting (translation), and other types of linear and affine transformations;
Linear filtering, convolution, linear prediction, and other types of signal processing operations;
Warping, clipping, nonlinear transformations, nonlinear prediction, and other nonlinear transformations.

Two or more of these functions can occur in various orders as can be advantageous or required for an application and produce a modified dataset. Aspects of these functions or the order of operations can be controlled by a user interface or other source, including an automated data formatting element or an analytic model. The invention further provides for updates to be provided to a native data set.

The invention provides for other types of pre-visualization operations as well. The invention also provides statistical operations and statistical processing functions to be used as pre-visualization operations as well as for linking to external programs to perform other types of pre-visualization operations. The invention also provides for external programs to be added to the collection of available pre-visualization operations.

FIG. 20 shows interactive user controls and/or other parameters are used to assign an index to a data set. The resultant indexed data set is assigned to one or more parameters as can be useful or required by an application. The resulting indexed parameter information is provided to a graphics rendering operation resulting in a graphics output. The the parameter assignment and/or sound rendering operations can be controlled by interactive control or other parameters. This control can be governed by a metaphor operation useful in the user interface operation or user experience.

The invention additionally provides for the inclusion and use of visual metaphors to simplify visualization setup and user interaction for data exploration. As an example, FIG. 20 also depicts that a selected metaphor is used to automatically generate parameter assignments and graphics rendering operations. The invention provides for metaphors to control other aspects of the visualization and pre-visualization operations. The invention provides for a metaphor to base its operations on characteristics of a data set being visualized, previously visualized, and/or anticipated to be visualized. The invention additionally provides for metaphors to be selected and controlled by user interaction, data values, or other means.

The invention also provides for array (vector, matrix, tensor) operations such as (vector, matrix, tensor) linear combinations, (vector, matrix, tensor) multiplication, scalar multiplication, finding (matrix, tensor) determinants, finding (matrix, tensor) inverses and psuedoinverses, row reduction, factorization, change of basis, or calculation of an eigensystem (eigenvalues, eigenvectors/eigentensors). Two or more of these functions can occur in various orders as can be advantageous or required for an application and produce a modified dataset. Aspects of these functions or the order of operations can be controlled by a user interface or other source, including an automated data formatting element or an analytic model. The invention further provides for updates to be provided to a native data set.

Additionally, at least the visualization aspects of the invention provide for:
data visualization graphics displayed superimposed on GIS graphics;
data visualization graphics displayed along side GIS graphics;
adopting the interactive format and metaphor of an interactive electronic spreadsheet for use in a tabular presentation of complex data visualization renderings;
superimposing a third (height) dimension atop the 2-dimensional tabular data layout of an interactive electronic spreadsheet.

In an embodiment, the invention comprises deeply integrated data visualization of data from various models, tools, and data sets. In an embodiment, the invention provides visualizations of analysis output data as well as selected measurement data.

Data visualization can be rendered either in a GIS display context or in an abstract data set context, as appropriate.

Additionally, as described below, the invention provides for data visualization to be used to support interactive adjustments of analysis software tools.

### Use of Data Sonification

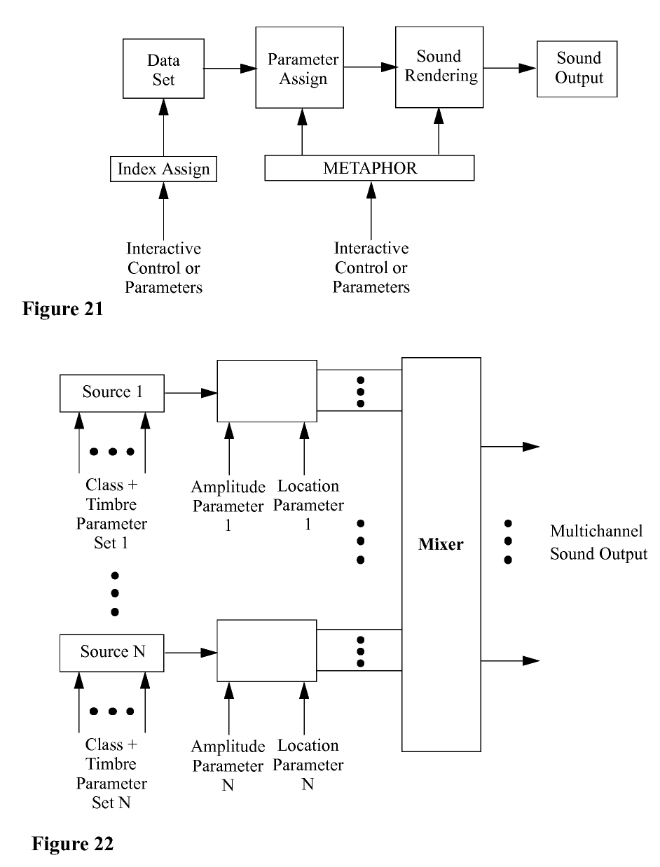

FIG. 21 shows interactive user controls and/or other parameters are used to assign an index to a data set. The resultant indexed data set is assigned to one or more parameters as can be useful or required by an application. The resulting indexed parameter information is provided to a sound rendering operation resulting in a sound (audio) output. The parameter assignment or sound rendering operations can be controlled by interactive control or other parameters. This control can be governed by a metaphor operation useful in the user interface operation or user experience.

FIG. 22 shows “multichannel sonification” using data-modulated sound timbre classes set in a spatial metaphor stereo sound field. The outputs can be stereo, four-speaker, or more complex, for example employing 2D speaker, 2D headphone audio, or 3D headphone audio so as to provide a richer spatial-metaphor sonification environment.

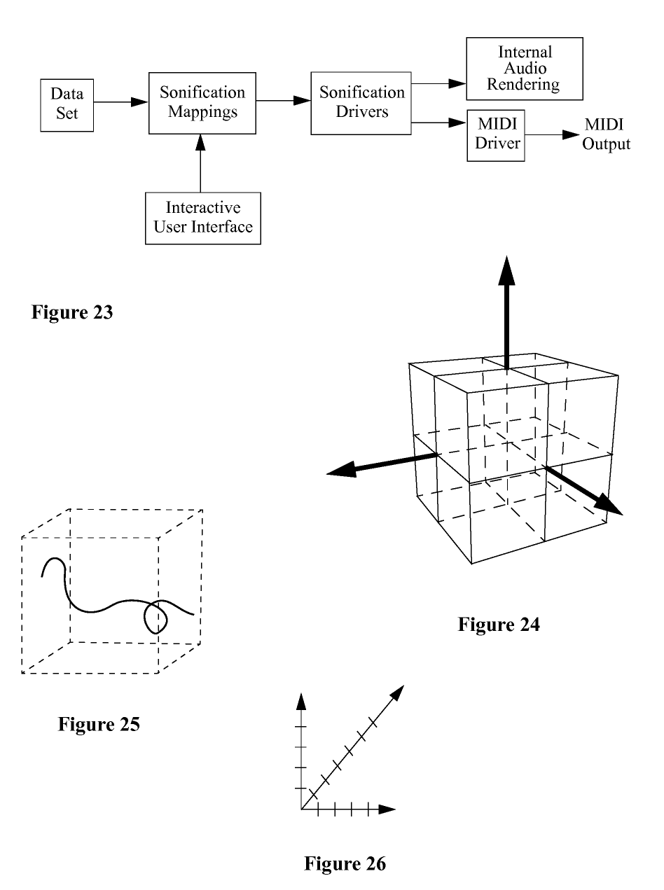

FIG. 23 shows an exemplary embodiment where dataset is provided to sonification mappings controlled by interactive user interface. Sonification mappings provide information to sonification drivers, which in turn provide information to internal audio rendering and a MIDI (Musical Instrument Digital Interface) driver.

Should pulse-width modulation be used, it can be advantageous to use zero-DC pulse-width modulation as taught in U.S. patent application Ser. No. 12/144,480 entitled “Variable Pulse-Width Modulation with Zero Constant DC Component in Each Period”, particularly if many such pulse waveforms are summed together.

FIG. 24 shows an exemplary embodiment of a three-dimensional partitioned timbre space. Here the timbre space has three independent perception coordinates, each partitioned into two regions. The partitions allow the user to sufficiently distinguish separate channels of simultaneously produced sounds, even if the sounds time modulate somewhat within the partition as suggested by FIG. 25. Alternatively, timbre spaces can have 1, 2, 4 or more independent perception coordinates.

An example signal generation technique providing a partitioned timber space is the system and method of U.S. Pat. No. 6,849,795 entitled “Controllable Frequency-Reducing Cross-Product Chain.” The harmonic spectral partition of the multiple cross-product outputs do not overlap. Other collections of audio signals also occupy well-separated partitions within an associated timbre space. Through proper sonic design, each timbre space coordinate can support several partition boundaries, as suggested in FIG. 26. Further, proper sonic design can produce timbre spaces with four or more independent perception coordinates.

### Use of Multidimensional User Interfaces

As mentioned earlier the invention provides for the support, inclusion, and use of multidimensional user interface devices for providing extra control parameters, 3D-geometry control and metaphors, 6D-geometry control and metaphors, etc. Such multidimensional user interface devices can include a High-Definition Touchpad such as that taught in U.S. Pat. No. 6,570,078 and U.S. patent applications Ser. Nos. 11/761,978 and 12/418,605, advanced computer mice such as that taught in U.S. Pat. No. 7,557,797 and U.S. patent application Ser. No. 10/806,694, video cameras such as taught in U.S. Pat. No. 6,570,078, or other types of touch, control-based, or visually operated user interfaces. Incorporation of and use of multidimensional user interface devices in interacting with data visualization and/or data sonification environments, either stand alone or in collaborative environments.

### Use of GIS and Data Visualizations as Interactive User Interface

FIG. 27 depicts a flow path that can be provided by a user interface built atop of and in terms of GIS and/or data visualization. The system can visually plot this data or use it to produce a sonification. Attention is directed to the depicted exemplary flow path (curved arrow line) through a visual representation (here, a satellite image) of the environment area under study as shown in FIG. 27 as it would be on a user interface display.

The visual plot or sonification can render representations of one or more data values according to a selected point selected by a cursor a cursor (shown as a small black box on the curved arrow line) on a flow path (curved arrow line), or as a function of time as a cursor (shown as a small black box on the curved arrow line) moves along the flow path at a specified rate.

The system can use kriging to interpolate among measured values. The system can visually display this data or use it to produce a sonification. The sonification can render sounds according to a selected point on the flow path, or as a function of time as a cursor moves along the flow path at a specified rate. For example, the system can produce a trajectory in sonfication parameter (timbre) space such as that depicted in FIG. 25, wherein as a cursor moves along the path in FIG. 27 the corresponding sonification rendered would simultaneously behave as prescribed by the trajectory in sonfication parameter (timbre) space depicted in FIG. 25.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. Therefore, the invention properly is to be construed with reference to the claims.

I claim:

1. An information system for environmental applications, the system comprising:
a data store having Graphical Information Systems (GIS) data;
an element for selecting data from the data store resulting in selected GIS data;
a GIS graphics rendering element for visually rendering GIS information from selected GIS data, the selected GIS data comprising a plurality of GIS data elements;
visual rendering software for displaying GIS graphics responsive to selected GIS data on a visual display device;
environmental data provided by a source of environmental data;
an element imposing an association between the environmental data and at least one GIS data element; and
visual rendering software for displaying data graphics responsive to the environmental data on the visual display device;
wherein the data graphics are displayed along with the GIS graphics.

2. The system of claim 1 wherein the environmental data was previously recorded.

3. The system of claim 2 wherein the environmental data was previously recorded from sensor telemetry.

4. The system of claim 1 wherein the environmental data is live real-time sensor telemetry.

5. The system of claim 1 further comprises multicriteria decision analysis (MCDA) software for analyzing data.

6. The system of claim 1 wherein the data graphics are displayed superimposed on the GIS graphics.

7. The system of claim 1 wherein the data graphics are displayed separately from the GIS graphics.

8. The system of claim 1 wherein the system further comprises a data sonification element for providing an audible representation of data in the system.

9. The system of claim 1 wherein the system is further provided with image data by sensor telemetry feeds, and further wherein the image data is displayed along with the GIS graphics.

10. The system of claim 9 wherein the image data comprises video.

11. An information system for environmental applications, the system comprising:
a data store comprising Graphical Information Systems (GIS) data;
an element for selecting data from the data store, resulting in selected GIS data;
a GIS graphics rendering element for rendering GIS information visually from selected GIS data, the selected GIS data comprising a plurality of GIS data elements;
visual rendering software for displaying GIS graphics responsive to selected GIS data on a visual display device;
environmental data provided by a source of environmental data;
an element imposing an association between the environmental data and at least one GIS data element;
analysis software for acting on at least the environmental data, producing analysis software output data, and
visual rendering software for displaying data graphics responsive to the analysis software output data on the visual display device;
wherein the data graphics are displayed along with the GIS graphics.

12. The system of claim 11 wherein the environmental data was previously recorded.

13. The system of claim 12 wherein the environmental data was previously recorded from sensor telemetry.

14. The system of claim 1 wherein the environmental data is live real-time sensor telemetry.

15. The system of claim 11 where the analysis software comprises multicriteria decision analysis (MCDA) software.

16. The system of claim 11 wherein the data graphics are displayed superimposed on the GIS graphics.

17. The system of claim 11 wherein the data graphics are displayed separately from the GIS graphics.

18. The system of claim 11 wherein the system further comprises a data sonification element for providing an audible representation of data in the system.

19. The system of claim 11 wherein the system is further provided with image data by sensor telemetry feeds, and further wherein the image data is displayed along with the GIS graphics.

20. The system of claim 19 wherein the image data comprises video.
